(19) United States
(12) Patent Application Publication
(10) Pub. No.: US 2005/0001796 A1
(43) Pub. Date: Jan. 6, 2005

(54) DUAL-DISPLAY FLAT DISPLAY DEVICE

(76) Inventor: Hong-Da LIU, Hsin-Chu Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 10/710,018

(22) Filed: Jun. 13, 2004

(30) Foreign Application Priority Data
Jul. 4, 2003 (TW) 092118421

(51) Int. Cl. G09G 3/36

(52) U.S. Cl. 345/87

(57) ABSTRACT

A dual-display flat display device having a first side and a second side opposite to first side includes a first light module for generating light beams, and a display panel having a transflective structure therein. Additionally, portions of the light beams are reflected by the transflective structure for displaying a first image on the first side of the dual-display flat display device, and portions of the light beams pass through the transflective structure for displaying a second image on the second side of the dual-display flat display device.

### BACKGROUND OF INVENTION

1. Field of the Invention

The present invention relates to a flat display device, and more specifically, to a dual-display flat display device.

2. Description of the Prior Art

Since market demand for cellular phones is growing rapidly, flat display devices used in the cellular phones become more and more important. In order to fulfill the requirements of user's habits and product innovation, the current trend is towards developing cellular phones equipped with flat display devices having a dual-display function.

The current existing flat display device having a dual-display function is usually fabricated by adhering two flat display devices to each other, but it has disadvantages of wasting materials and requiring a lot of electric power.

Since the conventional flat display device having a dual-display function consumes a lot of electric power, the power consumption of a cellular phone equipped with the conventional flat display device is increased so that users need to replace batteries very frequently, thereby leading to wasting energy. Furthermore, the conventional flat display device having a dual-display function cannot meet the requirements of small thickness and weight because it includes two flat display devices. As a result, it is an important issue to develop a thin and light flat display device having a dual-display function.

### SUMMARY OF INVENTION

It is therefore a primary objective of the claimed invention to provide a dual-display flat display device for solving the above-mentioned problem.

According to the claimed invention, a dual-display flat display device is provided. The dual-display flat display device having a first side and a second side opposite to first side includes a first light module for generating light beams, and a display panel having a transflective structure therein. Additionally, portions of the light beams are reflected by the transflective structure for displaying a first image on the first side of the dual-display flat display device, and portions of the light beams pass through the transflective structure for displaying a second image on the second side of the dual-display flat display device.

It is an advantage over the prior art that the claimed invention provides the transflective structure in the dual-display flat display device, so that images can be displayed on the first side and the second side of the dual-display flat display device, thereby reducing a volume and a production cost of the dual-display flat display device.

These and other objectives of the claimed invention will no doubt become obvious to those of ordinary skill in the art after reading the following detailed description of the preferred embodiment, which is illustrated in the multiple figures and drawings.

### BRIEF DESCRIPTION OF DRAWINGS

FIG. 1 is a schematic diagram of a dual-display flat display device of the present invention.

FIG. 2 is a schematic diagram of another dual-display flat display device of the present invention.

FIG. 3 and FIG. 4 illustrate display panels of the present invention.

FIG. 5 is a schematic diagram illustrating the array substrate within a pixel of the display panel shown in FIG. 3.

FIG. 6 and FIG. 7 are schematic diagrams illustrating array substrates according to other embodiments of the present invention.

FIG. 8 to FIG. 13 are schematic diagrams of color filter substrates according to the present invention.

FIG. 14 is a structural diagram of a dual-display flat display device according to the first embodiment of the present invention.

FIG. 15 illustrates a relationship between controlling of a switching element and brightness of a dual-display flat display device according to the present invention.

FIG. 16 is a structural diagram of a dual-display flat display device according to the second embodiment of the present invention.

FIG. 17 is a schematic diagram illustrating the prism sheet shown in FIG. 16.

FIG. 18 is a structural diagram of a dual-display flat display device according to the third embodiment of the present invention.

FIG. 19 is a schematic diagram illustrating a cellular phone equipped with a flat display device of the present invention that displays an image on its front side.

FIG. 20 is a schematic diagram illustrating the cellular phone of FIG. 19 that displays an image on a back side of the flat display device.

FIG. 21 illustrates images displayed on a front side and a back side of a flat display device according to the present invention.

FIG. 22 illustrates displaying methods of a dual-display flat display device according to the present invention.

FIG. 23 is a schematic diagram illustrating the cellular phone of FIG. 20 that displays a scaled-down image on the back side of the flat display device.

FIG. 24 illustrates dimensions of images displayed on the dual-display flat display device of the present invention.

### DETAILED DESCRIPTION

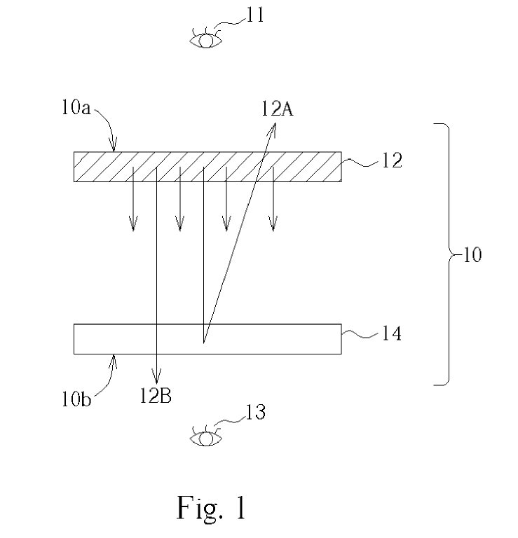

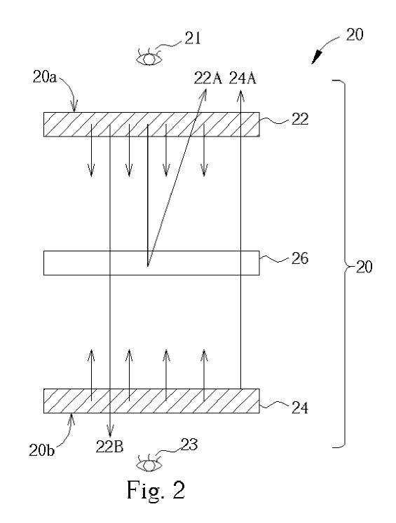

Please refer to FIG. 1. FIG. 1 is a schematic diagram of a dual-display flat display device according to the present invention. As shown in FIG. 1, a dual-display flat display device 10 includes a light module 12 having a planar shape for generating light beams 12A and 12B, and a display panel 14 having a transflective structure therein. The light beam 12A generated by the light module 12 is reflected to a first side 10a of the flat display device 10 by the transflective structure, so that a user 11 can see an image displayed on the first side 10a of the flat display device 10. Additionally, when the light beam 12B generated by the light module 12 passes through the display panel 14, a user 13 can see an image displayed on a second side 10b of the flat display device 10. Furthermore, the flat display device 10 may include two anti-reflective films (not shown) respectively positioned on an upper side and a lower side of the light module 12 for reducing reflection of light beams, and an optical adhesive (not shown) utilized for adhering the light module 12 to the display panel 14 and functioning to reduce reflection of light beams. Moreover, please refer to FIG. 2, which is a schematic diagram of another dual-display flat display device of the present invention. As shown in FIG. 2, a dual-display flat display device 20 includes a light module 22 having a planar shape for generating light beams 22A and 22B, a light module 24 having a planar shape for generating light beams 24A, and a display panel 26 having a transflective structure therein and positioned between the light module 22 and the light module 24. A user 21 can see an image displayed on a first side 20a of the flat display device 20 when the light beams 22A generated by the light module 22 are reflected to the first side 20a by the transflective structure, or when the light beams 24A generated by the light module 24 pass through the display panel 26 and the light module 22. In addition, a user 23 can see an image displayed on a second side 20b of the flat display device 20 when the light beams 22B generated by the light module 22 pass through the display panel 26 and the light module 24. Nevertheless, as shown in FIG. 2, the light beams 24A generated by the light module 24 cannot be reflected by the transflective structure to display an image the second side 20b of the flat display device 20. Furthermore, anti-reflective films may be formed on both sides of the light module 22 and on both sides of the light module 24 so as to reduce reflection of light beams, while optical adhesives functioning to reduce reflection of light beams may be utilized for adhering the light modules 22 and 24 to the display panel 26. In the preferred embodiments of the present invention, each of the display panels 14 and 26 can be an electrophoresis display panel, an active matrix light-emitting diode (LED) display panel, or a liquid crystal display (LCD) panel that can be a reflective super twisted nematic (RSTN) mode, a reflective twisted nematic (RTN) mode, a reflective electrically-controlled birefringence (RECB) mode, a mixed twisted nematic (MTN) mode, or a vertical alignment (VA) mode.

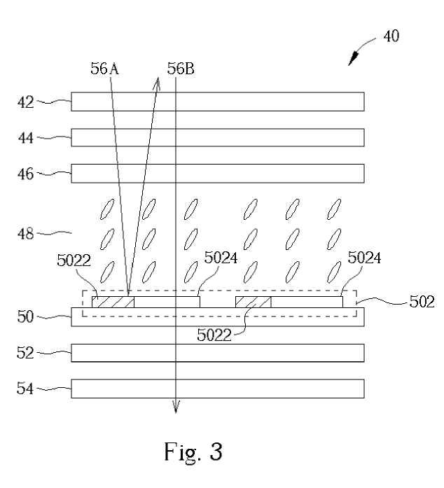

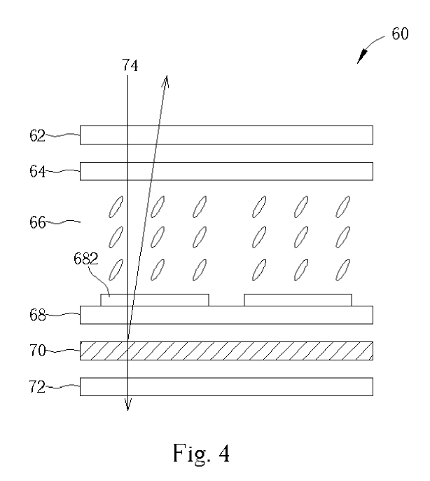

Additionally, the preferred structures of the display panels 14 and 26 shown in FIG. 1 and FIG. 2 are described as follows for explaining the present invention more explicitly. Please refer to FIG. 3 and FIG. 4. FIG. 3 and FIG. 4 illustrate display panels of the present invention. As shown in FIG. 3, a display panel 40 includes a polarizer 42, a compensation film 44, a color filter substrate 46, a liquid crystal layer 48, an array substrate 50, a compensation film 52, and a polarizer 54. The array substrate 50 comprises a transflective structure 502 having a plurality of reflective regions 5022 and a plurality of transmissive regions 5024. Each of the reflective regions 5022 is a reflector having a planar surface or an uneven surface. Light beams 56A are reflected to the polarizer 42 by the reflective regions 5022, while light beams 56B pass through the transmissive region 5024, the compensation film 52, and polarizer 54. In addition, FIG. 4 illustrates another kind of display panel of the present invention. As shown in FIG. 4, a display panel 60 includes a polarizer 62, a color filter substrate 64, a liquid crystal layer 66, an array substrate 68 having a plurality of transmissive regions 682, a transflective structure 70 that is a transflective film, and a polarizer 72. The transflective structure 70 can be utilized for not only reflecting light beams 74 but also allowing light beams 74 to pass through it. When the light beams 74 pass through the transmissive regions 682, portions of the light beams 74 are reflected to the polarizer 62 by the transflective structure 70 while portions of the light beams 68 pass through the transflective structure 70 and the polarizer 72. Additionally, both of the array substrates 50 and 68 can be applied in a semi-transmissive TN-LCD panel, a super TN LCD panel, a thin film transistor (TFT) LCD panel, an active matrix LED display panel, or a low-temperature polysilicon TFT-LCD panel.

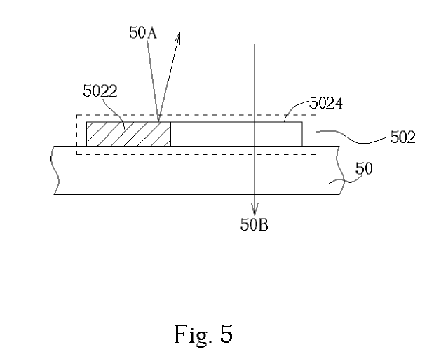

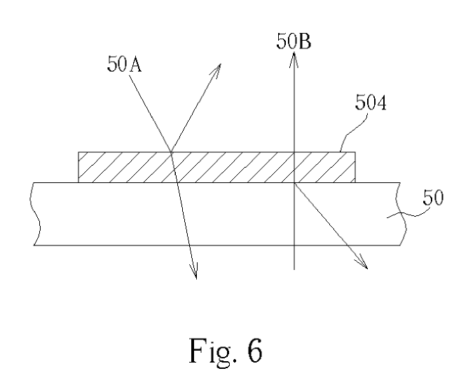

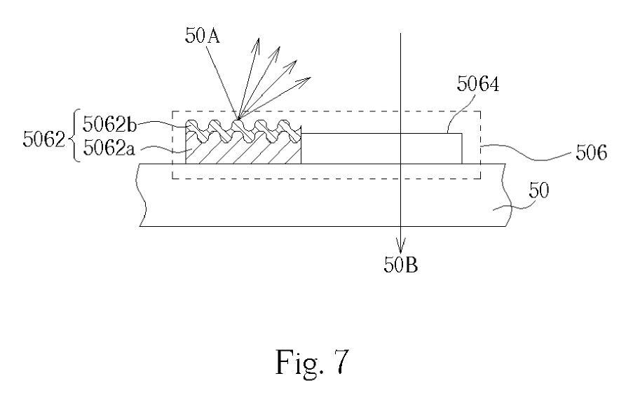

Additionally, please refer to FIG. 5. FIG. 5 is a schematic diagram illustrating the array substrate 50 within a pixel of the display panel 40 shown in FIG. 3. As shown in FIG. 5, the array substrate 50 includes the transflective structure 502 thereon. Additionally, the transflective structure 502 within a pixel includes at least one reflective region 5022 for reflecting light beams 50A and at least one transmissive region 5024 that allows light beams 50B to pass through it. Furthermore, it should be noticed that the structure of the array substrate of the present invention is not limited to that shown in FIG. 3 and FIG. 5, and please refer to FIG. 6 and FIG. 7, which are schematic diagrams illustrating the array substrates according to other embodiments of the present invention. As shown in FIG. 6, the array substrate 50 includes a transflective structure 504 thereon. The transflective structure 504 within a pixel is a transflective region for reflecting portions of light beams 50A and 50B and allowing portions of light beams 50A and 50B to pass through it. The transflective region 504 is usually composed of a metallic film whose thickness can be varied according to a ratio of transmittance of the light beams 50A, 50B to reflectance of the light beams 50A, 50B. In addition, another kind of array substrate is described as follows with reference to FIG. 7. As shown in FIG. 7, the array substrate 50 includes a transflective structure 506 thereon. The transflective structure 506 within a pixel includes at least a reflective region 5062 having an uneven surface for reflecting light beams 50A, and at least a transmissive region 5064 that allows light beams 50B to pass through it. Moreover, the reflective region 5062 includes a rough layer 5062a having an uneven surface and a reflective layer 5062b formed on the rough layer 5082, and both of the rough layer 5062a and the reflective layer 5062b are used to reflect light beams 50A. The rough layer 5082 is usually made of silicon nitride, silicon oxide or silicon oxynitride, while the reflective layer 5082 is made of a multi-layer reflective material, or a metal with high reflectivity, such as aluminum, silver, or an alloy of aluminum and silver.

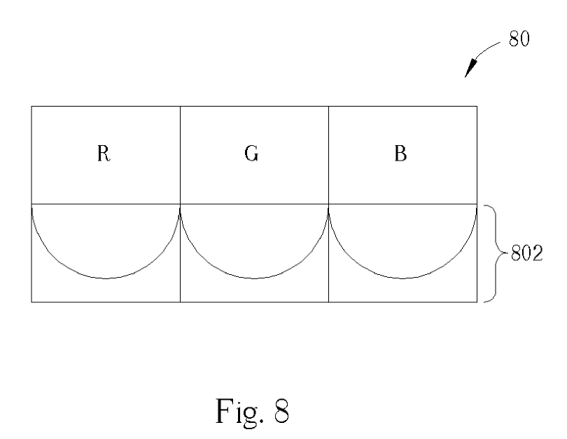

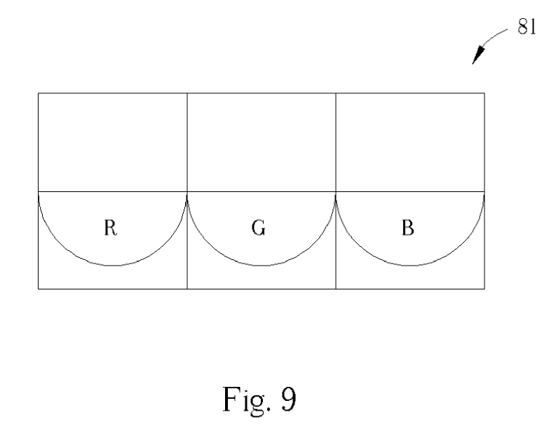

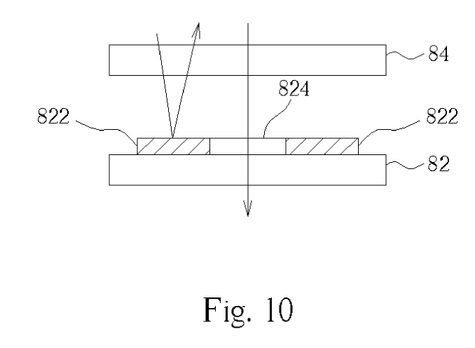

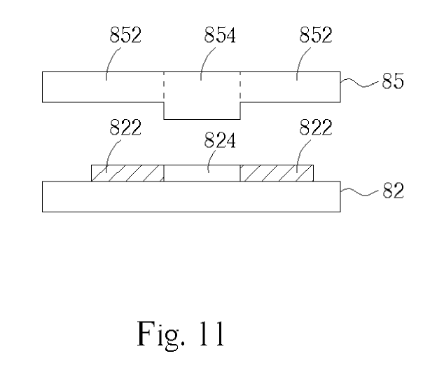

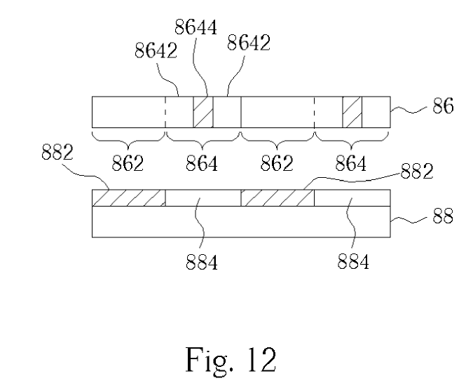

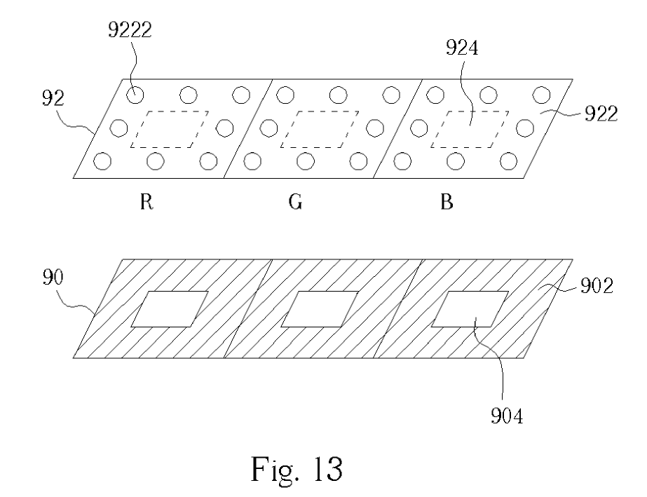

Furthermore, the following description will put emphasis on the detailed structures of the color filter substrates 46 and 64 shown in FIG. 3 and FIG. 4. Please refer to FIG. 8 to FIG. 13. FIG. 8 to FIG. 13 are schematic diagrams of color filter substrates according to the present invention. As shown in FIG. 8, a color filter substrate 80 includes at least a red color region R, a green color region G, a blue color region B, and a light-condensing structure 802 functioning to condense the light beams to the display panel and optionally comprising a plurality of micro lens. With reference to FIG. 9, another kind of color filter substrate 81 is made of a light-condensing material, such as a micro lens, which allows the light beams to be condensed to the display panel. In addition, please refer to FIG. 10, which illustrates another kind of color filter substrate of the present invention. As shown in FIG. 10, a color filter substrate 84 is a dual color filter. In addition, light beams reflected by a reflective region 822 on an array substrate 82 pass through the color filter substrate 84 twice, while light beams passing through a transmissive region 824 on the array substrate 82 pass through the color filter substrate 84 once. Additionally, the color filter substrate 84 above the reflective region 822 is made of the same material as the color filter substrate 84 above the transmissive region 824. Furthermore, please refer to FIG. 11. FIG. 11 illustrates another kind of color filter substrate of the present invention. As shown in FIG. 11, a color filter substrate 85 is a dual color filter having at least a first region 852 corresponding to each reflective region 822 on the array substrate 82, and at least a second region 854 corresponding to each transmissive region 824 on the array substrate 82. In addition, a thickness of the second region 854 is larger than a thickness of the first region 852, and further, a color and a material of the second region 854 can be different from those of the first region 852. Moreover, please refer to FIG. 12. FIG. 12 illustrates another kind of color filter substrate of the present invention. As shown in FIG. 12, a color filter substrate 86 is a dual color filter having at least a first region 862 corresponding to a reflective region 882 on an array substrate 88, and at least a second region 864 corresponding to a transmissive region 884 on the array substrate 88. The first region 862 includes red pigment, green pigment and blue pigment. Furthermore, the second region 864 includes at least a color region 8642 having red pigment, green pigment and blue pigment, and a pervious to light region 8644 that is used for color mixing and is usually made of a photoresist material. Please refer to FIG. 13. FIG. 13 illustrates another kind of color filter substrate of the present invention. As shown in FIG. 13, a color filter substrate 92 is a dual color filter having at least a first region 922 corresponding to a reflective region 902 on an array substrate 90, and at least a second region 924 corresponding to a transmissive region 904 on the array substrate 90. Furthermore, the first region 922 includes a plurality of previous to light regions 9222 that are used for color mixing and are usually made of a photoresist material. Additionally, a material, a color and a thickness of the first region 922 are the same as those of the second region 924.

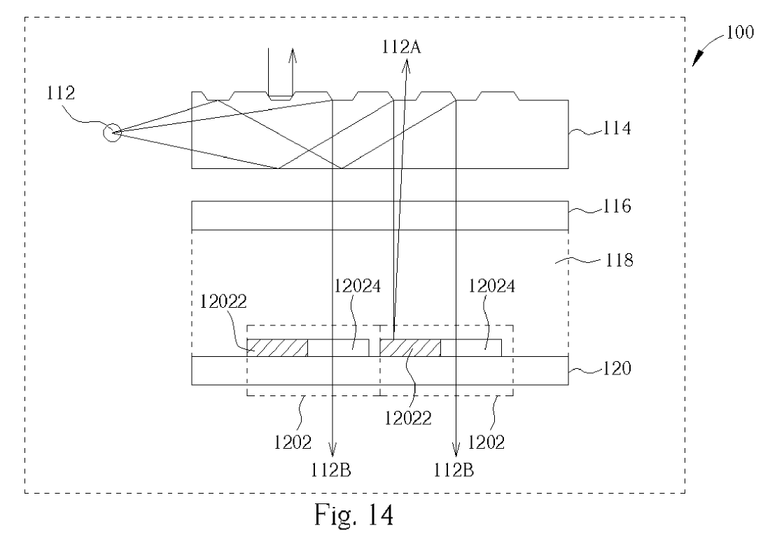

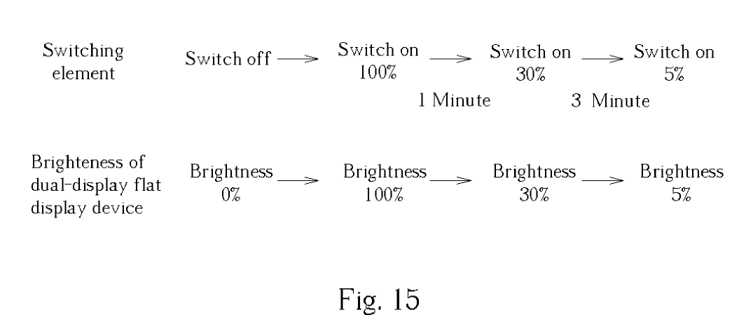

Please refer to FIG. 14. FIG. 14 is a structural diagram of a dual-display flat display device according to the first embodiment of the present invention. A dual-display flat display device 100 comprises a planar light module having a light source 112 and a light-guiding plate 114, a color filter substrate 116, a liquid crystal layer 118, and an array substrate 120. Light beams 112A and 112B generated by the light source 112 are guided by the light-guiding plate 114, and then, the light beams 112A and 112B are reflected to the color filter 114, the liquid crystal layer 118 and the array substrate 120 by the light-guiding plate 114. Each pixel 1202 on the array substrate 120 comprises a reflective region 12022 and a transmissive region 12024. The light beams 112A are reflected by the reflective region 12022 for displaying an image on a front side of the dual-display flat display device 100, and the light beams 112B pass through the transmissive region 12024 for displaying an image on a back side of the dual-display flat display device 100. The reflective region 12022 is a reflector having a planar surface or an uneven surface. The dual-display flat display device 100 is a flat display device that can be TN, STN, TFT, TFD or other modes. The color filter substrate 116 can be any one of the color filter substrates shown in FIGS. 8-13. The utilization of the light beams 112A is different from that of the light beams 112B since light beams 112A reflected by the reflective region 12022 pass through the color filter substrate 116 twice and the light beams 112A penetrating the transmissive region 12024 pass through the color filter substrate 116 once. Accordingly, the color filter substrate 116 is a dual color filter so that an image displayed on the front side can have the same quality as an image displayed on the back side of the dual-display flat display device 100. Additionally, the dual-display flat display device 100 further comprises a switching element for controlling brightness of the light source 112 according to brightness of an ambient environment. Please refer to FIG. 15. FIG. 15 illustrates a relationship between controlling of a switching element and brightness of a dual-display flat display device according to the present invention. As shown in FIG. 15, when the switching element is switched off, brightness of the dual-display flat display device is zero. Furthermore, the brightness of the dual-display flat display device is varied with the controlling of the switching element.

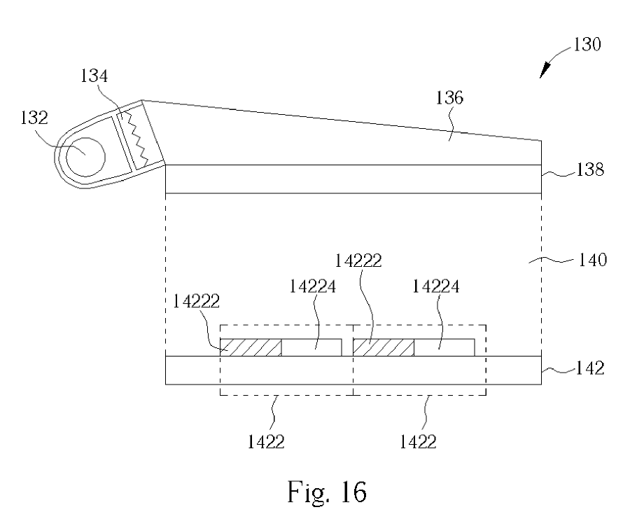

Please refer to FIG. 16. FIG. 16 is a structural diagram of a dual-display flat display device according to the second embodiment of the present invention. A dual-display flat display device 130 comprises a planar light module having a light source 132, a prism sheet 134 and a light-guiding plate 136, a color filter substrate 138, a liquid crystal layer 140, and an array substrate 142. The prism sheet 134 directs light beams generated by the light source 132 to the light-guiding plate 136. Then, the light beams are guided by the light-guiding plate 136, and are reflected to the color filter 138, the liquid crystal layer 140 and the array substrate 142 by the light-guiding plate 136. Each pixel 1422 on the array substrate 142 comprises a reflective region 14222 and a transmissive region 14224. The light beams are reflected by the reflective region 14222 for displaying an image on a front side of the dual-display flat display device 130, and the light beams pass through the transmissive region 14224 for displaying an image on a back side of the dual-display flat display device 130. The reflective region 14222 is a reflector having a planar surface or an uneven surface. The dual-display flat display device 130 is a flat display device that can be TN, STN, TFT, TFD or other modes. The dual-display flat display device 130 utilizes the color filter substrate 138 and controls rotation of the liquid crystal molecules in the liquid crystal layer 140 for displaying a colorful image. Since the utilization of the light beams reflected by the reflective region 14222 is different from that of the light beams passing through the transmissive region 14224, the color filter 138 is a dual color filter so that an image displayed on the front side can have the same quality as an image displayed on the back side of the dual-display flat display device 130. Additionally, the dual-display flat display device 130 further comprises a switching element for controlling brightness of the light source 132 based on brightness of an ambient environment.

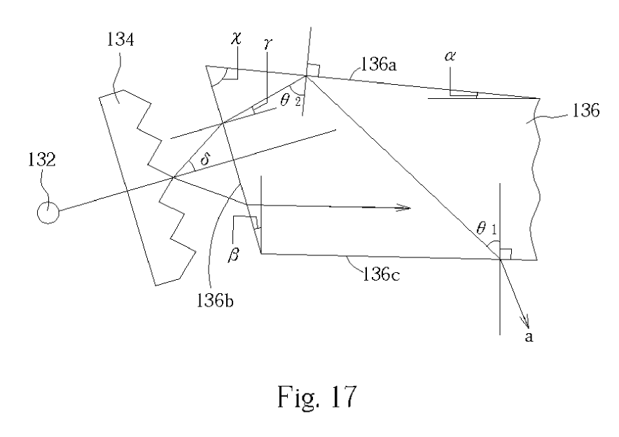

Please refer to FIG. 17. FIG. 17 is a schematic diagram illustrating the prism sheet 134 shown in FIG. 16. The light-guiding plate 136 has a first plane 136a having an inclination angle α, an second plane 136b, and a third plane 136c. Additionally, the light-guiding plate 136 further has an included angle x between the first plane 136a and the second plane 136b, and an included angle β between the second plane 136b and a normal. The angle x should be an acute angle so that light beams generated by the light source 132 can move along a path of light beams a. Firstly, the light beams a are dispersed after the light beams a pass through the prism sheet 134, and a divergence angle that is between the dispersed light beams a and the original path of the light beams a is δ. When the dispersed light beams a enter the light-guiding plate 136 through the second plane 136b, the dispersed light beams a is refracted and a refraction angle of the dispersed light beams a is γ. Then, the refracted light beams a are incident on the first plane 136a and an incident angle of the light beams a is θ₂, and then, the refracted light beams a are reflected by the first plane 136a. Thereafter, the reflected light beams a are incident on the third plane 136c and an incident angle of the light beams a is θ₁. Finally, the light beams a leave the light-guiding plate 136 through the third plane 136c. It should be noticed that the incident angle θ₂ should satisfy (EQ-1) so that the utilization of light beams can be increased and the consumption of electric power can be reduced.
90 °−α−β−γ≦θ₂≦90 °−α−β+γ (EQ-1)

Furthermore, the incident angle θ₁ should satisfy (EQ-2).
θ₁=θ₂−α (EQ-2)

Moreover, the incident angle θ₁ should be smaller than a critical angle of the light-guiding plate 136, so that the light beams a can leave the light-guiding plate 136 and enter the liquid crystal layer 140. According to (EQ-2), increasing the inclination angle α can enable the incident angle θ₁ to be smaller than the critical angle of the light-guiding plate 136.

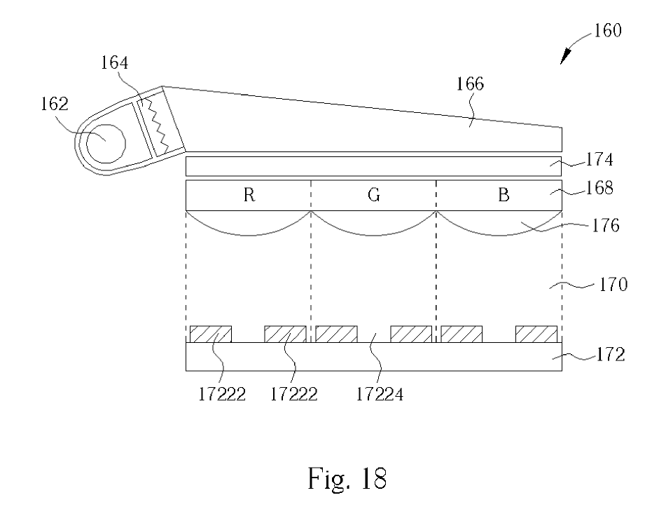

Please refer to FIG. 18. FIG. 18 is a structural diagram of a dual-display flat display device according to the third embodiment of the present invention. A dual-display flat display device 160 comprises a planar light module having a light source 162, a prism sheet 164 and a light-guiding plate 166, a color filter substrate 168, a liquid crystal layer 170, and an array substrate 172. The prism sheet 164 directs light beams generated by the light source 162 to the light-guiding plate 166. Then, the light beams are guided by the light-guiding plate 166, and are reflected to the color filter substrate 168, the liquid crystal layer 170 and the array substrate 172 by the light-guiding plate 166. Each pixel on the array substrate 172 comprises a reflective region 17222 and a transmissive region 17224. The light beams are reflected by the reflective region 17222 for displaying an image on a front side of the dual-display flat display device 160, and the light beams pass through the transmissive region 17224 for displaying an image on a back side of the dual-display flat display device 160. The dual-display flat display device 160 further comprises a light-scattering layer 174 for smoothly distributing light beams that have passed through the light-guiding plate 166. The dual-display flat display device 160 is a flat display device that can be TN, STN, TFT, TFD, or other modes. The color filter substrate 168 within each pixel comprises a red-color region, a blue-color region, and a green-color region so that the dual-display flat display device 160 can display a colorful image. Since the utilization of the light beams reflected by the reflective region 17222 is different from that of the light beams passing through the transmissive region 17224, the color filter substrate 138 is a dual color filter so that an image displayed on the front side can have the same quality as an image displayed on the back side of the dual-display flat display device 160. Additionally, the dual-display flat display device 160 further comprises a switching element for controlling brightness of the light source 162 based on brightness of an ambient environment. The dual-display flat display device 160 further comprises a plurality of micro lenses 176 for condensing light beams to the transmissive regions 17224. When the micro lenses 176 are applied in the dual-display flat display device 160, the reflective regions 17222 should have uneven surfaces for increasing the reflection of light beams. Additionally, a length of the surface of each reflective region 17222 is between 10 nm and 800 nm, and a height of each reflective region 17222 is between 5 nm and 100 nm. The reflective layer 17222 is made of a multi-layer reflective material, or a metal with high reflectivity, such as aluminum or silver. A image quality of the dual-display flat display device can be improved due to using micro lenses 176 and the reflective regions 17222 with uneven surfaces, increasing a total area of the reflective regions 17222 and reducing a total area of the transmissive regions 17224. A percentage of the total area of the reflective regions 17222 is between 5% and 85%, and a percentage of the total area of the transmissive regions 17224 is between 5% and 85%. Increasing the total area of the reflective regions 17222 can improve the brightness of the image displayed on the front side of the dual-display flat display device 160, but decreasing the total area of the transmissive regions 17224 may lower the brightness of the image displayed on the back side of the dual-display flat display device 160. Accordingly, the present invention adds the micro lenses 176 to increase the transmittance of the transmissive regions 17224, thereby improving an image quality of the dual-display flat display device 160. The light-guiding plate 166 and the prism sheet 164 are respectively the same as the light-guiding plate 136 and the prism sheet 134 shown in FIG. 16.

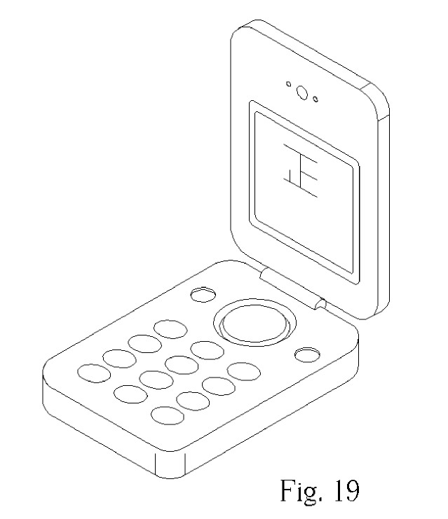

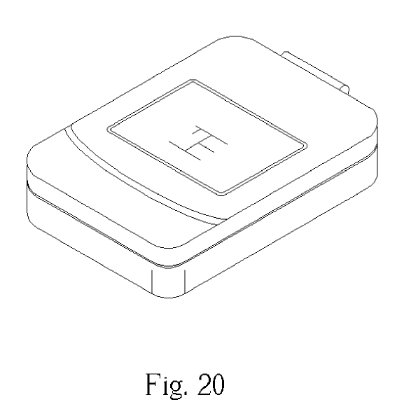

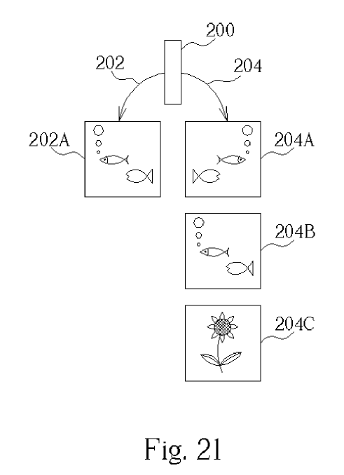

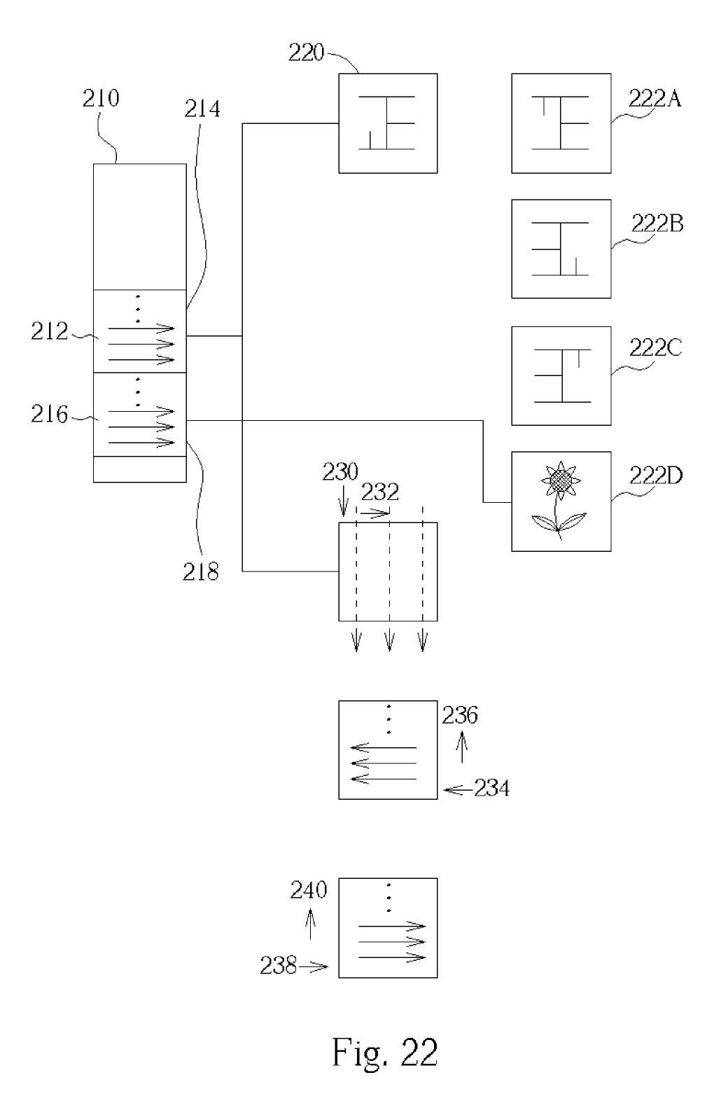

Please refer to FIG. 19 to FIG. 21. FIG. 19 is a schematic diagram illustrating a cellular phone equipped with a dual-display flat display device of the present invention that displays an image on its front side, and FIG. 20 is a schematic diagram illustrating the cellular phone of FIG. 19 that displays an image on a back side of the dual-display flat display device. Additionally, FIG. 21 illustrates images displayed on a front side 202 and a back side 204 of a dual-display flat display device 200 according to the present invention. As shown in FIG. 21, when an image 202A is displayed on the front side 202 of the flat display device 200, the back side 204 of the flat display device 200 can display an image 204A that is the same as the image 202A, an image 204B that is a mirror image of the image 202A, or an image 204C that is different from the image 202A. It should be noticed that the first side 202 and the second side 204 of FIG. 21 display images asynchronously. Furthermore, please refer to FIG. 22. FIG. 22 illustrates displaying methods of a dual-display flat display device according to the present invention. As shown in FIG. 22, image data 212 of the dual-display flat display device are stored in a block 214 of a memory 210, and are read out from the block 214 of the memory 210 when the dual-display flat display device starts to display an image. In addition, the present invention provides two kinds of displaying methods for the dual-display flat display device to display images. As shown in FIG. 22, the first displaying method of the present invention is to determine a starting point of the image data 212. Beginning with the starting point, the image data 212 is successively read out from the block 214 of the memory 210 so that the dual-display flat display device can display images. By use of the first displaying method, an image 220 is displayed on a front side of the dual-display flat display device, and a back side of the dual-display flat display device can display an image 222A that is a vertical mirror image of the image 220, an image 222B that a horizontal mirror image of the image 220, or an image 222C that is both a horizontal mirror image and a vertical mirror image of the image 220. As shown in FIG. 22, the second displaying method is to divide the image data 212 first, and then, to determine a starting position of the image data 212 so as to rear-range the divided image data 212. For example, the starting position can be a position 230 and the divided image data 212 are rearranged along a direction indicated by an arrow 232. Additionally, the starting position also can be a position 234 and the divided image data 212 are rear-ranged along a direction indicated by an arrow 236, or the starting position can be a position 238 and the divided image data 212 are rearranged along a direction indicated by an arrow 240. Therefore, according to the above-mentioned displaying methods, the image displayed on the front side of the dual-display flat display device can be the same as or a mirror image of the image displayed on the back side of the dual-display flat display device. Moreover, as shown in FIG. 22, the dual-display flat display device further comprises an image data 216 that are different from the image data 212 and are stored in a block 218 of the memory 210. By use of the above-mentioned displaying methods, the image data 216 can be read out to display an image 222D on the back side of the dual-display flat display device, so that the front side and the back side of the dual-display flat display device can display different images asynchronously.

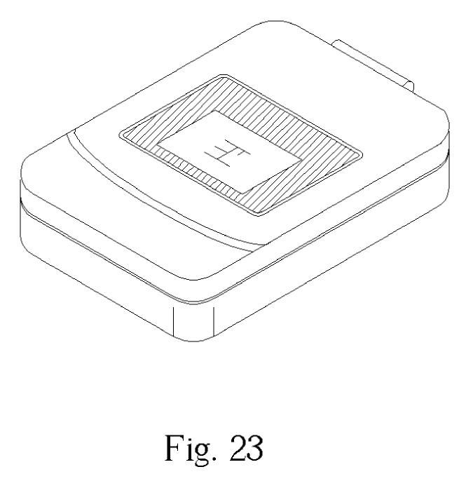

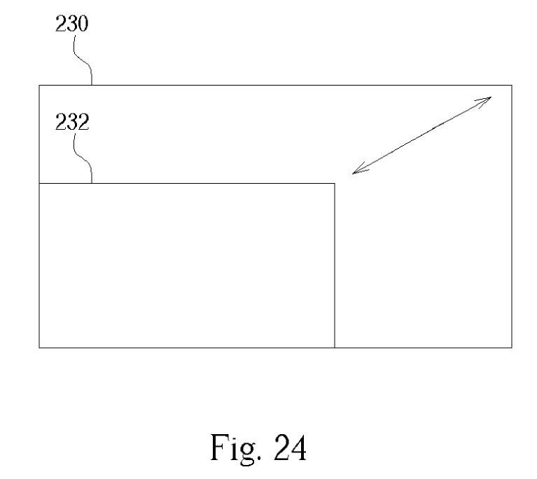

Please refer to FIG. 23. FIG. 23 is a schematic diagram illustrating the cellular phone of FIG. 20 that displays a scaled-down image on the back side of the dual-display flat display device. By use of the above-mentioned displaying methods and proper calculation methods, the present invention can display an enlarged image or a scaled-down image on the front side of the dual-display flat display device, as well as on the back side of the dual-display flat display device. Please refer to FIG. 24. FIG. 24 illustrates dimensions of images displayed on the dual-display flat display device of the present invention. As shown in FIG. 24, an image 230 is displayed according to image data having a size of 176*220, and the image 230 can be scaled down to an image 232 having a size of 128*160.

The dual-display flat display device of the present invention has a thickness of 3.5 mm and a weight of 30 g, but the prior art dual-display flat display device has a thickness of 6 mm and a weight greater than 30 g. Therefore, the weight of the dual-display flat display device of the present invention is 50%-70% smaller than that of the prior art dual-display flat display device, and the thickness of the dual-display flat display device of the present invention is 40%-60% smaller than that of the prior art dual-display flat display device. As a result, the dual-display flat display device of the present invention occupies less volume and space than the prior art dual-display flat display device when the dual-display flat display device of the present invention is applied in cellular phones. Furthermore, in comparison with the prior art dual-display flat display device, the reduction in power consumption of the dual-display flat display device of the present invention is about 30%, so that a production cost of the present invention is about 60% of a production cost of the prior art. Therefore, the production cost is effectively reduced in the present invention.

Those skilled in the art will readily observe that numerous modifications and alterations of the device may be made while retaining the teachings of the invention. Accordingly, the above disclosure should be construed as limited only by the metes and bound of the appended claims.

1. A dual-display flat display device having a first side and a second side opposite to first side comprising:
a first light module for generating light beams; and
a display panel having a transflective structure therein, wherein portions of the light beams are reflected by the transflective structure for displaying a first image on the first side of the dual-display flat display device, and portions of the light beams pass through the transflective structure for displaying a second image on the second side of the dual-display flat display device.

2. The dual-display flat display device of claim 1 further comprising a second light module for generating light beams to pass through the transflective structure for displaying the first image on the first side of the dual-display flat display device.

3. The dual-display flat display device of claim 1 wherein the display panel comprises a first substrate, a second substrate positioned between the first substrate and the first light module, and a liquid crystal layer positioned between the first substrate and the second substrate.

4. The dual-display flat display device of claim 3 wherein the first substrate is positioned between the transflective structure and the liquid crystal layer.

5. The dual-display flat display device of claim 3 wherein the transflective structure is positioned between the first substrate and the liquid crystal layer and comprises a plurality of transflective regions.

6. The dual-display flat display device of claim 5 wherein the transflective structure comprises a plurality of reflective regions and a plurality of transmissive regions.

7. The dual-display flat display device of claim 6 wherein each of the reflective regions is a reflector comprising a planar surface or an uneven surface.

8. The dual-display flat display device of claim 7 wherein the second substrate is a color filter.

9. The dual-display flat display device of claim 8 wherein the color filter is a light-condensing color filter.

10. The dual-display flat display device of claim 9 wherein the color filter is a dual color filter having a plurality of first regions respectively corresponding to the reflective regions of the transflective structure, and a plurality of second regions respectively corresponding to the transmissive regions of the transflective structure.

11. The dual-display flat display device of claim 10 wherein a thickness of each first region is smaller than a thickness of each second region.

12. The dual-display flat display device of claim 10 wherein a thickness of each first region is the same as a thickness of each second region.

13. The dual-display flat display device of claim 10 wherein each of the first regions comprises at least a pervious to light region.

14. The dual-display flat display device of claim 10 wherein each of the second regions comprises at least a pervious to light region.

15. The dual-display flat display device of claim 8 further comprising a light-condensing structure positioned on the second substrate for condensing portions of the light beams generated by the first light module to the transmissive regions of transflective structure.

16. The dual-display flat display device of claim 15 wherein the light-condensing structure comprises a plurality of micro lenses.

17. The dual-display flat display device of claim 1 wherein the first light module comprises a light source for generating light beams, a light-guiding plate for guiding the light beams generated by the light source, and a switching element for controlling brightness of the light source.

18. The dual-display flat display device of claim 1 wherein the first image and the second image are asynchronously displayed on the first side and the second side.

19. The dual-display flat display device of claim 18 wherein the first image is a mirror image of the second image.

20. The dual-display flat display device of claim 18 wherein the first image and the second image are scaled-down images.

21. The dual-display flat display device of claim 18 wherein the first image is different from the second image.

22. The dual-display flat display device of claim 18 further comprising a memory for storing image data that are read out to display the first image and the second image.

23. The dual-display flat display device of claim 22 wherein the image data are read out to display the first image and the second image by determining a starting point.

24. The dual-display flat display device of claim 22 wherein the image data are read out to display the first image and the second image by dividing the image data and determining a starting position of the divided image data.

25. The dual-display flat display device of claim 1 wherein the display panel comprises a liquid crystal display panel, an electrophoresis display panel, or an active matrix light-emitting diode display panel.
